(19) United States
(12) Patent Application Publication
(10) Pub. No.: US 2022/0405585 A1
(43) Pub. Date: Dec. 22, 2022

(54) TRAINING DEVICE, ESTIMATION DEVICE, TRAINING METHOD, AND TRAINING PROGRAM

(71) Applicant: NIPPON TELEGRAPH AND TELEPHONE CORPORATION, Tokyo (JP)

(72) Inventors: Atsutoshi KUMAGAI, Musashino-shi, Tokyo (JP); Tomoharu IWATA, Musashino-shi, Tokyo (JP)

(73) Assignee: NIPPON TELEGRAPH AND TELEPHONE CORPORATION, Tokyo (JP)

(21) Appl. No.: 17/764,995

(22) PCT Filed: Oct. 16, 2019
(86) PCT No.: PCT/JP2019/040777

§ 371 Date: Mar. 30, 2022

(51) Int. Cl. G06N 3/08

(52) U.S. Cl. CPC G06N 3/08

(57) ABSTRACT

A latent representation calculation unit (131) uses a first model to calculate, from samples belonging to a domain, a latent representation representing a feature of the domain. A domain-by-domain objective function generation unit (132) and an all-domain objective function generation unit (133) generate, from the samples belonging to the domain and from the latent representation of the domain calculated by the latent representation calculation unit (131), an objective function related to a second model that calculates an anomaly score of each of the samples. An update unit (134) updates the first model and the second model so as to optimize the objective functions of a plurality of the domains calculated by the domain-by-domain objective function generation unit (132) and the all-domain objective function generation unit (133).

### TECHNICAL FIELD

The present invention relates a learning device, an estimation device, a learning method, and a learning program.

### BACKGROUND ART

Anomaly detection refers to a technique of detecting, as anomaly, a sample having a behavior different from those of a majority of normal samples. The anomaly detection is used in various actual applications such as intrusion detection, medical image diagnosis, and industrial system monitoring.

Anomaly detection approaches include semi-supervised anomaly detection and supervised anomaly detection. The semi-supervised anomaly detection is a method that learns an anomaly detector by using only normal samples and performs anomaly detection by using the anomaly detector. Meanwhile, the supervised anomaly detection is a method that learns an anomaly detector by also using anomalous samples in addition to and in combination with the normal samples.

Normally, the supervised anomaly detection uses both of the normal samples and the anomalous samples for learning, and therefore exhibits performance higher than that exhibited by the semi-supervised anomaly detection in most cases. Meanwhile, the anomalous samples, which are rare, are oftentimes hard to obtain and, in most cases, a supervised anomaly detection approach cannot be used to solve actual problems.

Meanwhile, there is a case where, even when anomalous samples are unavailable in a domain of interest (referred to as a target domain), anomalous samples are available in a domain related thereto (referred to as a related domain). For example, in a field of cyber security, there is service that unitarily monitors networks of a plurality of clients and detects a sign of a cyber attack. Even when a network (target domain) of a new client has no data (anomalous sample) when being attacked, it is highly possible that such data is available from a network (related domain) of an existing client which has been monitored over a long period. Likewise, in monitoring of an industrial system also, no anomalous sample is available from a newly introduced system (target domain) but, in an existing system (related domain) that has operated over a long period, an anomalous sample may possibly be available.

In view of circumstances as described above, a method is proposed which uses, in addition to normal samples from a target domain, normal or anomalous samples obtained from a plurality of related domains to learn an anomaly detector.

There has been known a method that uses a neural network to learn new feature values from samples from related domains in advance and uses the learned feature values and normal samples from a target domain to further learn an anomaly detector based on a semi-supervised anomaly detection method (see, e.g., NPL 1).

There has also been known a method that uses normal and anomalous samples from a plurality of related domains to learn a function that performs transform from parameters of a normal sample generating distribution to parameters of an anomalous sample generating distribution (see, e.g., NPL 2). In this method, parameters of a normal sample generating distribution of a target domain are input to the learned function to simulatively generate parameters of anomalous samples and, using the parameters of the normal and anomalous sample generating distributions, an anomaly detector appropriate for the target domain is built.

### CITATION LIST

### Non Patent Literature

[NPL 1] J. T. Andrews, T. Tanay, E. J. Morton, L. D. Griffin. “Transfer representation-learning for anomaly detection.” In Anomaly Detection Workshop in ICML, 2016.
[NPL 2] J. Chen, X. Liu. “Transfer learning with one-class data.” Pattern Recognition Letters, 37:32-40, 2014.

### SUMMARY OF THE INVENTION

### Technical Problem

However, these methods encounter problems when applied to actual problems. Specifically, in NPL 1, it may be difficult to perform accurate anomaly detection without learning samples from the target domain. For example, with the prevalence of IoT (Internet of Things) in recent years, there have been an increasing number of case examples in which anomaly detection is performed in an IoT device such as a sensor, a camera, or a vehicle. In such case examples, it may be required to perform anomaly detection without learning samples from a target domain.

For example, since the IoT device does not have sufficient calculation resources, even when the samples from the target domain are acquired successfully, it is difficult to perform high-load learning in such a terminal. In addition, while cyber attacks on IoT devices have also rapidly increased, there are a variety of IoT devices (such as, e.g., a vehicle, a television set, and a smartphone. Features of data differ depending on types of vehicles) and, since new IoT devices appear one after another on the market, if high-cost training is performed every time a new IoT device (target domain) appears, it is impossible to immediately respond to a cyber attack.

Since the method described in NPL 1 is based on the assumption that normal samples from the target domain are usable during learning, the problem described above arises. Meanwhile, in the method described in NPL 2, by learning a transform function for parameters in advance, it is possible to perform anomaly detection immediately (without performing learning) when samples from the target domain are given. However, since it is required to estimate the anomalous sample generating distribution of the related domain, when only a small quantity of anomalous samples are available, the generating distribution cannot accurately be produced, and it is difficult to perform accurate anomaly detection.

### Means for Solving the Problem

To solve the problem described above and attain the object, a learning device of the present invention includes: a latent representation calculation unit that uses a first model to calculate, from samples belonging to a domain, a latent representation representing a feature of the domain; an objective function generation unit that generates, from the samples belonging to the domain and from the latent representation of the domain calculated by the latent representation calculation unit, an objective function related to a second model that calculates an anomaly score of each of the samples; and an update unit that updates the first model and the second model so as to optimize the objective functions of a plurality of the domains calculated by the objective function generation unit.

### Effects of the Invention

According to the present invention, it is possible to perform accurate anomaly detection without learning samples from a target domain.

### BRIEF DESCRIPTION OF DRAWINGS

FIG. 1 is a diagram illustrating an example of respective configurations of a learning device and an estimation device according to a first embodiment.

FIG. 2 is a diagram illustrating an example of a configuration of a learning unit.

FIG. 3 is a diagram illustrating an example of a configuration of an estimation unit.

FIG. 4 is a diagram for illustrating learning processing and estimation processing.

FIG. 5 is a flow chart illustrating a flow of processing in the learning device according to the first embodiment.

FIG. 6 is a flow chart illustrating a flow of processing in the estimation device according to the first embodiment.

FIG. 7 is a diagram illustrating an example of a computer that executes a learning program or an estimation program.

### DESCRIPTION OF EMBODIMENTS

The following will describe embodiments of a learning device, an estimation device, a learning method, and a learning program each according to the present application in detail based on the drawings. Note that the present invention is not limited by the embodiments described below.

### Configuration of First Embodiment

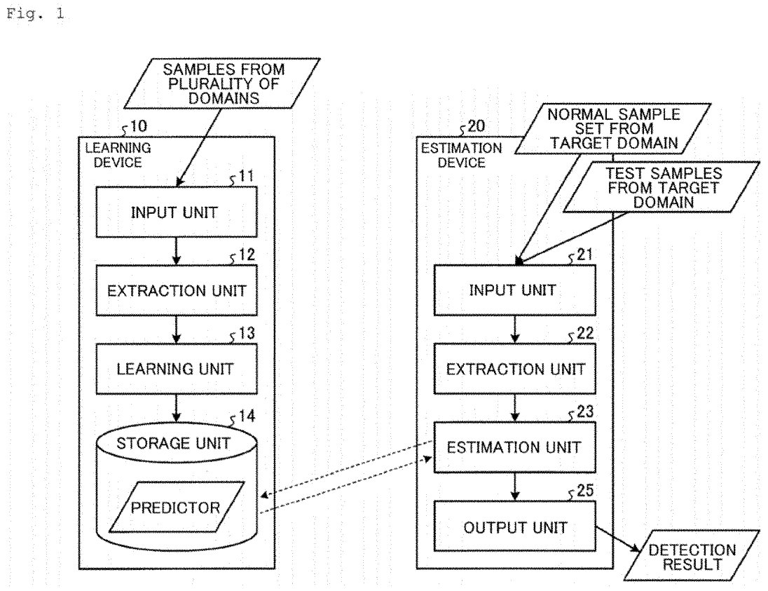

Using FIG. 1, a description will be given of respective configurations of a learning device and an estimation device according to the first embodiment. FIG. 1 is a diagram illustrating an example of the respective configurations of the learning device and the estimation device according to the first embodiment. Note that a learning device 10 and an estimation device 20 may also be configured as one device.

First, a description will be given of the configuration of the learning device 10. As illustrated in FIG. 1, the learning device 10 includes an input unit 11, an extraction unit 12, a learning unit 13, and a storage unit 14. A target domain is a domain on which anomaly detection is to be performed. Meanwhile, related domains are domains related to the target domain.

The input unit 11 receives samples from a plurality of domains input thereto. To the input unit 11, only normal samples from the related domains or both of the normal samples and anomalous samples therefrom are input. To the input unit 11, normal samples from the target domain may also be input.

The extraction unit 12 transforms each of the samples input thereto to a pair of a feature vector and a label. The feature vector mentioned herein is a representation of a feature of required data in the form of an n-dimensional numerical vector. The extraction unit 12 can use a method typically used in machine learning. For example, when the data is a text, the extraction unit 12 can perform transform based on morphological analysis, transform using n-gram, transform using delimiting characters, or the like. The label is a tag representing “anomaly” or “normality”.

The learning unit 13 learns, using sample data after feature extraction, “an anomaly detector predictor” (which may be hereinafter referred to simply as the predictor) that outputs, from a normal sample set from each of the domains, an anomaly detector appropriate for the domain. As the base anomaly detector, a method used for semi-supervised anomaly detection such as an autoencoder, a Gaussian mixture model (GM), or kNN can be used.

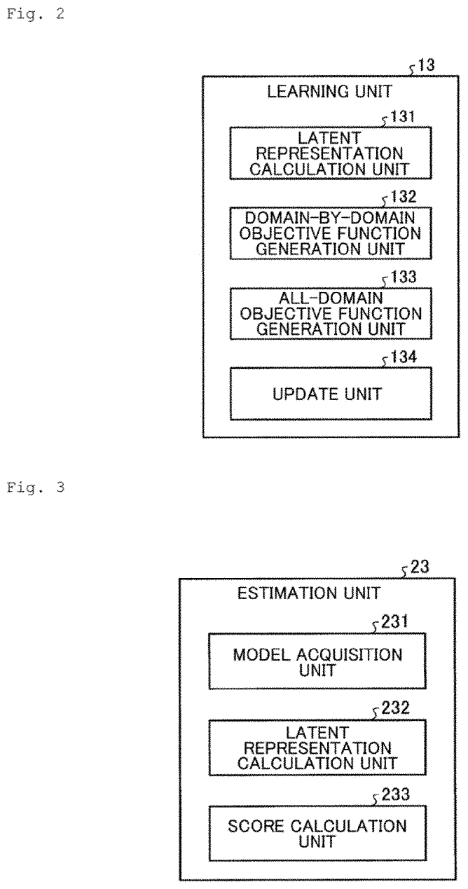

FIG. 2 is a diagram illustrating an example of a configuration of the learning unit. As illustrated in FIG. 2, the learning unit 13 includes a latent representation calculation unit 131, a domain-by-domain objective function generation unit 132, an all-domain objective function generation unit 133, and an update unit 134. Processing in each of the units of the learning unit 13 will be described later.

Next, a description will be given of the configuration of the estimation device 20. As illustrated in FIG. 1, the estimation device 20 includes an input unit 21, an extraction unit 22, an estimation unit 23, and an output unit 25. To the input unit 21, a normal sample set from the target domain or a test sample set from the target domain is input. The test sample set include samples normality or anomaly of which is unknown. Note that, after receiving the normal sample set once, the estimation device 20 can perform detection by receiving the test samples.

The extraction unit 22 transforms each of the samples input thereto to a pair of a feature vector and a label, similarly to the extraction unit 12. The estimation unit 23 uses a learned predictor to output an anomaly detector from the normal sample set. The estimation unit 23 uses the obtained anomaly detector to estimate whether each of the test samples is anomalous or normal. The estimation unit 23 also stores the anomaly detector and can perform estimation using the stored anomaly detector thereafter when test samples from the target domain are input thereto.

The output unit 25 outputs a detection result. For example, the output unit 25 outputs, based on an estimation result from the estimation unit 23, whether each of the test samples is anomalous or normal. Alternatively, the output unit 25 may also output, as the detection result, a list of the test samples estimated to be anomalous by the estimation unit 23.

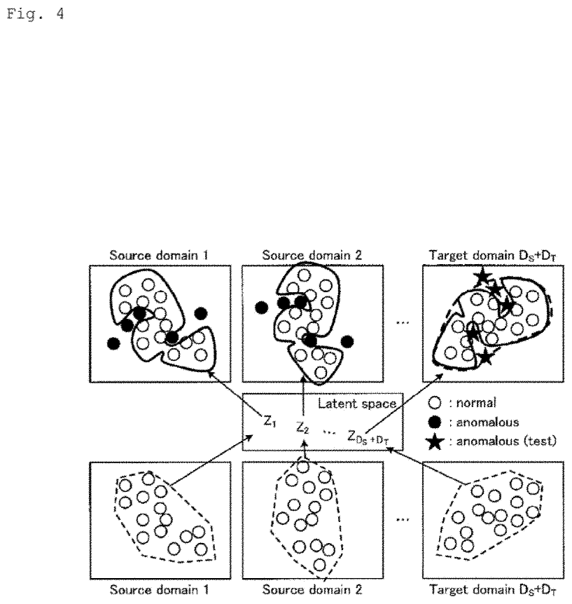

FIG. 3 is a diagram illustrating an example of a configuration of the estimation unit. As illustrated in FIG. 3, the estimation unit 23 includes a model acquisition unit 231, a latent representation calculation unit 232, and a score calculation unit 233. Processing in each of the units of the estimation unit 23 will be described later.

Learning processing by the learning device 10 and estimation processing by the estimation device 20 will be described herein in detail. FIG. 4 is a diagram for illustrating the learning processing and the estimation processing. In FIG. 4, Target domain represents the target domain, while Source domain 1 and Source domain 2 represent the related domains.

As illustrated in FIG. 4, the learning device 10 calculates, from the normal sample set from each of the domains, a latent domain vector z_{d} representing a feature of the domain and learns the predictor that generates the anomaly detector by using the latent domain vector. Then, when the normal samples from the target domain are given thereto, the estimation device 20 generates the anomaly detector appropriate for the target domain by using the learned predictor and can perform anomaly detection on the test samples (anomalous (test)) by using the generated anomaly detector. Accordingly, when the predictor is already learned, the estimation device 20 need not perform re-learning of the target domain.

It is assumed herein that an anomalous sample set from a d-th related domain is given by an expression (1-1). It is also assumed that x_{dn} represents an M-dimensional feature vector of the n-th anomalous sample from the d-th related domain. Likewise, it is assumed that a normal sample set from the d-th related domain is given by an expression (1-2). It is also assumed that, in each of the related domains, the number of the anomalous samples is extremely smaller than the number of the normal samples. In other words, when it is assumed that N_{d}⁺ represents the number of the anomalous samples and N_{d}⁻ represents the number of the normal samples, N_{d}⁺<<N_{d}⁻ is satisfied.

$$[ Math . 1 ]$$

$${X}_{d}^{+} := {\{ {x}_{dn}^{+} \}}_{n = 1}^{{N}_{d}^{+}} \qquad ( 1 - 1 )$$

$${X}_{d}^{-} := {\{ {x}_{dn}^{-} \}}_{n = 1}^{{N}_{d}^{-}} \qquad ( 1 - 2 )$$

It is assumed now that the anomalous samples and the normal samples from D_{S} related domains each shown in an expression (2-1) and the normal samples from D_{T} target domains each shown in an expression (2-2) are given. At this stage, the learning unit 13 performs processing for generating a function s_{d} that calculates an anomaly score. Note that the function s_{d} is a function that outputs, when a sample x from a domain d is input thereto, an anomaly score representing a degree of anomaly of the sample x. Such a function s_{d} is hereinafter referred to as an anomaly score function.

[Math. 2]

{X_{d}⁺∪X_{d}⁻}_{d=1}^{D}^{_{S}} (2-1)

{X_{d}⁻}d=_{D}_{ₛ}₊₁^{D}^{_{S}}^{|D}^{_{T}} (2-2)

The anomaly score function in the present embodiment is based on a typical autoencoder (AE). Note that the anomaly score function may also be an anomaly score function based not only on the AE, but also on any semi-supervised anomaly detection method such as a GMM (Gaussian mixture model) or a VAE (Variational AE).

When N samples X={x₁, . . . , and x_{N}} are given, typical learning by an autoencoder is performed by optimizing an objective function given by an expression (3).

$$[ Math . 3 ]$$

$$L ( {θ}_{F} , {θ}_{G} ) := \frac{1}{N} {\sum }_{n = 1}^{N} {‖ {x}_{n} - {G}_{{θ}_{G}} ( {F}_{{θ}_{F}} ( {x}_{n} ) ) ‖}^{2} \qquad ( 3 )$$

F represents a neural network referred to as an encoder, while G represents a neural network referred to as a decoder. Normally, to an output of F, a dimension lower than d dimension of the input x is set. In the autoencoder, when x is input thereto, x is transformed by F into a lower dimension, and then x is restored again by G.

When X represents a normal sample set, the autoencoder can correctly restore X. Meanwhile, when X represents an anomalous sample set, it can be expected that the autoencoder will not be able to correctly restore X. Accordingly, the typical autoencoder can use a reconstruction error shown in an expression (4) as the anomaly score function.

[Math. 4]

∥xₙ−G_{θ}_{_{G}}(F_{θ}_{_{F}}(xₙ))∥² (4)

In the present embodiment, to efficiently represent a characteristic of each of the domains, it is assumed that the d-th domain has a K-dimensional latent representation z_{d}. A K-dimensional vector representing the latent representation z_{d} is referred to as the latent domain vector. The anomaly score function in the present embodiment is defined as in an expression (5) by using the latent domain vector. Note that an anomaly score function s_{θ} is an example of a second model.

[Math. 5]

s_{θ}(x_{dn}|z_{d}):=∥x_{dn}−G_{θ}_{_{G}}(F_{θ}_{_{F}}(xₙ,z_{d}))∥² (5)

It is assumed herein that θ=(θ_{F}, θ_{G}) is a parameter of the encoder F and the decoder G. As shown in the expression (5), the encoder F depends on the latent domain vector and, accordingly, in the present embodiment, by varying z_{d}, it is possible to vary a characteristic of the anomaly score function of each of the domains.

Since the latent domain vector z_{d}, is unknown, the learning unit 13 estimates the latent domain vector z_{d} from the given data. As a model for estimating the latent domain vector z_{d}, a Gaussian distribution given by an expression (6) is assumed herein.

[Math. 6]

q_{ϕ}(z_{d}|X_{d}⁻):= [symbol] (z_{d}|μ_{ϕ}(X_{d}⁻),Iσ_{ϕ}²(X_{d}⁻)) (6)

Each of a mean function and a covariance function of the Gaussian distribution is modelled by a neural network having a parameter ϕ. When a normal sample set X_{d}⁻ from the domain d is input to the neural network having the parameter ϕ, a Gaussian distribution of the latent domain vector z_{d} corresponding to the domain is obtained.

The latent representation calculation unit 131 uses a first model to calculate, from samples belonging to the domain, a latent representation representing a feature of the domain. In other words, the latent representation calculation unit 131 uses the neural network having the parameter ϕ serving as an example of the first model to calculate the latent domain vector z_{d}.

The Gaussian distribution is represented by the mean function and the covariance function. Meanwhile, each of the mean function and the covariance function is represented by an architecture shown in an expression (7). In the expression (7), τ represents the mean function or the covariance function, while each of ρ and η represents any neural network.

Then, the latent representation calculation unit 131 calculates the latent representation based on the Gaussian distribution which is represented as an output obtained through further inputting of the total sum of the outputs obtained through inputting of each of the samples belonging to the domain to ρ to η by each of the mean function and the covariance function. At this time, η represents an example of a first neural network, while ρ represents an example of a second neural network.

For example, the latent representation calculation unit 131 calculates τₐᵥₑ (X_{d}⁻) by using a mean function τₐᵥₑ having neural networks ρₐᵥₑ and ηₐᵥₑ. The latent representation calculation unit 131 also calculates τ_{cov}(X_{d}⁻) by using a covariance function τ_{cov} having neural networks ρ_{cov} and η_{cov}.

A function based on the architecture in the expression (7) can constantly return a given output irrespective an order of samples in a sample set. In other words, to a function based on the architecture in the expression (7), a set can be input. Note that the architecture in this form can also represent average pooling or max pooling.

[Math. 7]

τ(X_{d}⁻)=ρ(Σₙ₌₁^{N}^{_{d}}^{^{−}}η(x_{dn}⁻)) (7)

The domain-by-domain objective function generation unit 132 and the all-domain objective function generation unit 133 generate, from the samples belonging to the domain and from the latent representation of the domain calculated by the latent representation calculation unit 131, an objective function related to the second model that calculates the anomaly scores of the samples. In other words, the domain-by-domain objective function generation unit 132 and the all-domain objective function generation unit 133 generate, from the normal samples from the related domains and the target domain and from the latent representation vector z_{d}, an objective function for learning the anomaly score function s_{θ}.

The domain-by-domain objective function generation unit 132 generates the objective function of the d-th related domain as shown in an expression (8). It is assumed herein that λ represents a positive real number and f represents a sigmoid function. In the objective function given by the expression (8), a first term represents an average of the anomaly scores of the normal samples and a second term represents a successive approximation of an AUC (Area Under the Curve), which is minimized when scores of the anomalous samples are larger than scores of the normal samples. By minimizing the objective function given by the expression (8), learning is performed such that the anomaly scores of the normal samples decrease and the anomaly scores of the anomalous samples are larger than those of the normal samples.

$$[ Math . 8 ]$$

$${L}_{d} ( θ \vert {z}_{d} ) := \frac{1}{{N}_{d}^{-}} {\sum }_{η = 1}^{{N}_{d}^{-}} {s}_{θ} ( {x}_{dn}^{-} \vert {z}_{d} ) - \frac{λ}{{N}_{d}^{-} {N}_{d}^{+}} {\sum }_{n = 1}^{{N}_{d}^{-} , {N}_{d}^{+}} f ( {s}_{θ} ( {x}_{d m}^{+} \vert {z}_{d} ) - {s}_{θ} ( {x}_{dn}^{-} \vert {z}_{d} ) ) \qquad ( 8 )$$

The anomaly score function se corresponds to the reconstruction error. Accordingly, it can be said that the domain-by-domain objective function generation unit 132 generates the objective function based on the reconstruction error when the samples and the latent representation calculated by the latent representation calculation unit 131 are input to the autoencoder to which the latent representation can be input.

The objective function given by the expression (8) has been conditioned by the latent domain vector z_{d}. Since the latent domain vector is estimated from data, uncertainty related to the estimation is involved therein. Accordingly, the domain-by-domain objective function generation unit 132 generates a new objective function based on an expected value in the expression (8), as shown in an expression (9).

[Math. 9]

[symbol]

_{d}(θ,ϕ):= [symbol] _{q}_{_{ϕ}}_{(z}_{_{d}}_{|X}_{_{d}}_{^{−)}}[L_{d}(θ|z_{d})]+βD_{KL}(q_{ϕ}(z_{d}|X_{d}⁻)∥p(z_{d})) (9)

In the expression (9), a first term represents the expected value of the objective function in the expression (8), which is an amount considering all probabilities that can be assumed by the latent domain vector z_{d}, i.e., the uncertainty, and therefore robust estimation can be performed. Note that the domain-by-domain objective function generation unit 132 can obtain the expected value by performing integration of the objective function in the expression (8) for the probabilities of the latent domain vector z_{d}. Thus, the domain-by-domain objective function generation unit 132 can generate the objective function by using the expected value of the latent representation in accordance with the distribution.

In the objective function given by the expression (9), a second term represents a regularization term that prevents overfitting of the latent domain vector and β specifies an intensity of the regularization, while P(z_{d}) represents a standard Gaussian distribution and serves as a prior distribution. By minimizing the objective function given by the expression (9), the parameter ϕ is learned so as to allow the latent domain vector z_{d} that increases the scores of the anomalous samples and reduce the scores of the normal samples in the domain d to be output, while restrictions of the prior distribution are observed.

Note that, when the normal samples from the target domain are successfully obtained, the domain-by-domain objective function generation unit 132 can generate the objective function based on the average of the anomaly scores of the normal samples, as shown in an expression (10). The objective function given by the expression (10) is based on the expression (8) from which the successive approximation of the AUC has been removed. Consequently, the domain-by-domain objective function generation unit 132 can generate, as the objective function, a function that calculates an average of the anomaly scores of the normal samples or a function that subtracts the approximation of the AUC from the average of the anomaly scores of the normal samples.

$$[ Math . 10 ]$$

$${ℒ}_{d} ( θ , ϕ ) := {{q}_{ϕ} ( {z}_{d} \vert {X}_{d}^{-} )}_{} [ \frac{1}{{N}_{d}^{-}} {\sum }_{n = 1}^{{N}_{d}^{-}} {s}_{A} ( {x}_{dn}^{-} \vert {z}_{d} ) ] + β {D}_{KL} ( {q}_{ϕ} ( {z}_{d} \vert {X}_{d}^{-} ) ∥ p ( {z}_{d} ) ) \qquad ( 10 )$$

In addition, the all-domain objective function generation unit 133 generates the objective function for all the domains, as shown in an expression (11).

[Math. 11]

[symbol]

_{d}(θ,ϕ):=Σ_{d=1}^{D}^{_{S}}^{+D}^{_{T}}α_{d} [symbol] _{d}(θ,ϕ) (11)

It is assumed herein that α_{d} represents a positive real number representing a degree of importance of the domain d. The objective function given by the expression (11) can be differentiated and minimized using any gradient-based optimization method. The objective function given by the expression (11) includes various cases. For example, when samples from the target domain cannot be obtained during learning, the all-domain objective function generation unit 133 may appropriately set α_{d}=0 for the target domain and set α_{d}=1 for the related domains. Note that, in the present embodiment, even when the samples from the target domain cannot be obtained during learning, it is possible to output an anomaly score function appropriate for the target domain.

The update unit 134 updates the first model and the second model so as to optimize the objective functions of the plurality of domains calculated by the domain-by-domain objective function generation unit 132 and the all-domain objective function generation unit 133.

The first model in the present embodiment is a neural network having the parameter ϕ for calculating the latent domain vector z_{d}. Accordingly, the update unit 134 updates parameters of the neural networks ρₐᵥₑ and ηₐᵥₑ of the average function and also updates parameters of the neural networks ρ_{cov} and η_{cov} of the covariance function. Meanwhile, the second model is the anomaly score function, and therefore the update unit 134 updates the parameter θ of the anomaly score function. The update unit 134 also stores each of the updated parameters as the predictor in the storage unit 14.

Back to FIG. 3, the model acquisition unit 231 acquires, from the storage unit 14 of the learning device 10, the predictors, i.e., a parameter ϕ* of a function for calculating the latent domain vector and a parameter θ* of the anomaly score calculation function.

The score calculation unit 233 obtains the anomaly score function from a normal sample set X_{d′}⁻ of a target domain d′, as shown in an expression (12). Actually, the score calculation unit 233 uses an approximate expression on a third side of an expression (12) as the anomaly score. The approximate expression on the third side represents random obtention of L latent domain vectors.

At this time, as shown in the expression (12), the latent representation calculation unit 232 calculates, based on the parameter ϕ*, μ and σ for each of the L latent domain vectors. The normal sample set from the target domain input herein may be that used during learning or that not used during learning.

Thus, the latent representation calculation unit 232 calculates, from the samples belonging to the domain, latent representations of the plurality of related domains related to the target domain by using the first model that calculates the latent representation representing the feature of the domain.

The score calculation unit 233 estimates whether each of the test samples from the target domain is normal or anomalous based on whether or not a score obtained by inputting the test sample to the third side of the expression (12) is equal to or more than a threshold.

$$[ Math . 12 ]$$

$$s ( {x}_{{d}^{′}} ) := \int {s}_{θ .} ( {x}_{{d}^{′}} \vert {z}_{{d}^{′}} ) {q}_{ϕ .} ( {z}_{{d}^{′}} \vert {x}_{{d}^{′}}^{-} ) {dz}_{{d}^{′}} \approx \frac{1}{L} {\sum }_{l = 1}^{L} {s}_{θ .} ( {x}_{{d}^{′}} \vert {z}_{{d}^{′}}^{( l )} ) \\ where \\ {z}_{{d}^{′}}^{( l )} = {μ}_{ϕ .} ( {X}_{{d}^{′}}^{-} ) + {ϵ}^{( l )} ⊙ {σ}_{ϕ .} ( {X}_{{d}^{′}}^{-} ) , {c}^{( l )} \sim ( 0 , 1 ) \qquad ( 12 )$$

is satisfied and x_{d′} represents any instance from a d′-th domain.

In other words, the score calculation unit 233 inputs, to the anomaly score function, each of L latent representations of the related domains together with a sample x_{d′} from the target domain and calculates an average of L anomaly scores obtained from the anomaly score function.

### Processing in First Embodiment

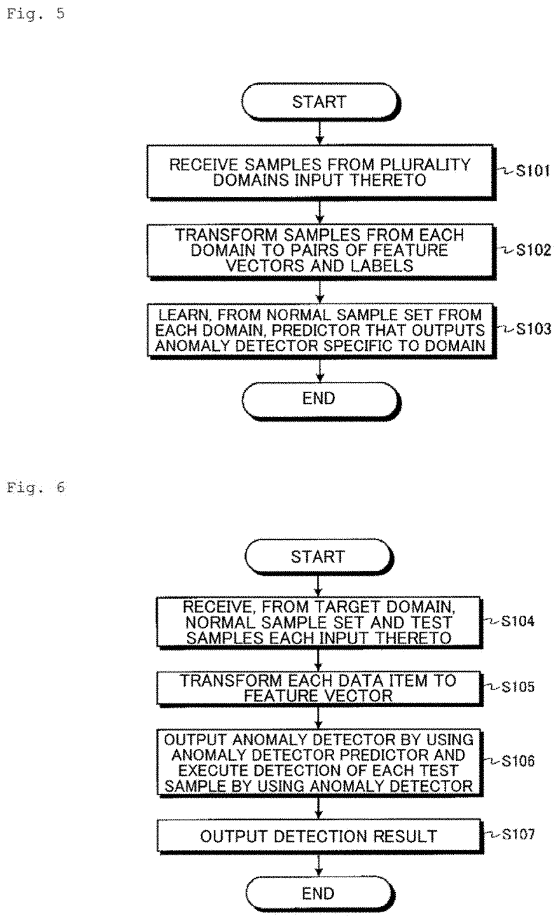

FIG. 5 is a flow chart illustrating a flow of processing in the learning device according to the first embodiment. As illustrated in FIG. 5, the learning device 10 receives the samples from the plurality of domains input thereto (Step S101). The plurality of domains mentioned herein may or may not include the target domain.

Next, the learning device 10 transforms the samples from the individual domains to pairs of feature vectors and labels (Step S102). Then, the learning device 10 learns, from the normal sample sets from the individual domains, the predictors that output the anomaly detectors specific to the domains (Step S103).

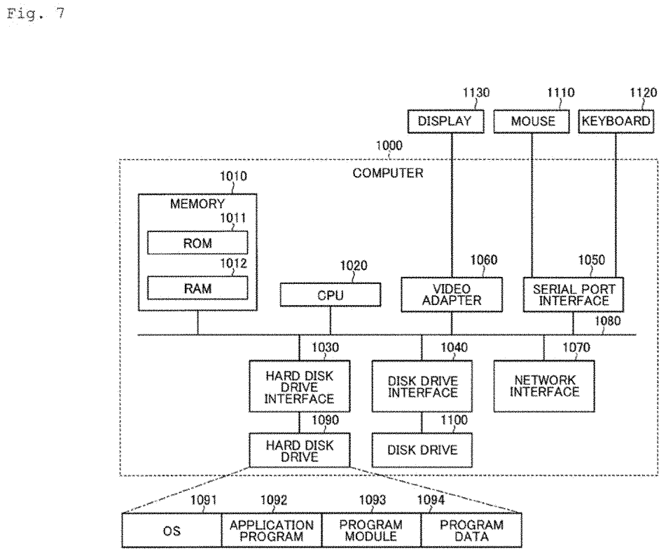

FIG. 6 is a flow chart illustrating a flow of processing in the estimation device according to the first embodiment. As illustrated in FIG. 6, the estimation device 20 receives, from the target domain, the normal sample set and the test samples as input (Step S104). Then, the estimation device 20 transforms each of data items to the feature vector (Step S105).

The estimation device 20 outputs the anomaly detectors by using the anomaly detection predictors, performs detection of the individual test samples by using the output anomaly detectors (Step S106), and outputs detection results (Step S107). In other words, the estimation device 20 calculates the latent feature vector from the normal samples from the target domain, generates the anomaly score function by using the latent feature vector, and inputs the test samples to the anomaly score function to estimate normality or anomaly.

### Effects of First Embodiment

As has been described heretofore, the latent representation calculation unit 131 uses the first model to calculate, from the samples belonging to each of the domains, the latent representation representing the feature of the domain. Also, the domain-by-domain objective function generation unit 132 and the all-domain objective function generation unit 133 generate, from the samples belonging to the domain and from the latent representation of the domain calculated by the latent representation calculation unit 131, the objective function related to the second model that calculates the anomaly scores of the samples. Also, the update unit 134 updates the first model and the second model so as to optimize the objective functions of the plurality of domains calculated by the domain-by-domain objective function generation unit 132 and the all-domain objective function generation unit 133. Thus, the learning device 10 can learn the first model from which the second model can be predicted. The second model mentioned herein is a model that calculates the anomaly score. Then, during estimation, from the learned first model, the second model can be predicted. Accordingly, with the learning device 10, it is possible to perform accurate anomaly detection without learning the samples from the target domain.

Also, the latent representation calculation unit 131 can calculate the latent representation based on the Gaussian distribution which is represented as the output obtained through further inputting of the total sum of the outputs obtained through inputting of each of the samples belonging to the domain to the first neural network to the second neural network by each of the mean function and the covariance function. Thus, the learning device 10 can calculate the latent representation by using the neural networks. Therefore, the learning device 10 can improve accuracy of the first model by using a learning method for the neural networks.

Also, the update unit 134 can update, as the first model, the first neural network and the second neural network for each of the mean function and the covariance function. Thus, the learning device 10 can improve the accuracy of the first model by using the learning method for the neural networks.

The domain-by-domain objective function generation unit 132 can generate the objective function by using the expected value of the latent representation in accordance with the distribution. Accordingly, even when the latent representation is represented by an object having uncertainty such as a probability distribution, the learning device 10 can obtain the objective function.

In addition, the domain-by-domain objective function generation unit 132 can generate, as the objective function, the function that calculates the average of the anomaly scores of the normal samples or the function that subtracts, from the average of the anomaly scores of the normal samples, the approximation of the AUC. This allows the learning device 10 to obtain the objective function even when there is no anomalous sample and obtain a more accurate objective function when there is an anomalous sample.

The domain-by-domain objective function generation unit 132 can also generate the objective function based on the reconstruction error when the samples and the latent representation calculated by the latent representation calculation unit 131 are input to the autoencoder to which a latent representation can be input. This allows the learning device 10 to improve accuracy of the second model by using a learning method for the autoencoder.

The latent representation calculation unit 232 can calculate, from the samples belonging to the domain, the latent representations of the plurality of related domains related to the target domain by using the first model that calculates the latent representation representing the feature of the domain. At this time, the score calculation unit 233 inputs, to the second model that calculates the anomaly scores of the samples from the latent representation of the domain calculated using the first model, each of the latent representations of the related domains together with the sample from the target domain and calculates the average of the anomaly scores obtained from the second model. Thus, the estimation device 20 can obtain the anomaly score function without performing re-learning of the normal samples. The estimation device 20 can further calculate the anomaly scores of the test samples from the target domain by using the already obtained anomaly score function.

[System Configuration, Etc.]

Each of the constituent elements of each of the devices illustrated in the drawings is functionally conceptual and need not necessarily be physically configured as illustrated in the drawings. In other words, specific forms of distribution and integration of the individual devices are not limited to those illustrated in the drawings and all or part thereof may be configured in a functionally or physically distributed or integrated manner in an optionally selected unit depending on various loads, use situations, and the like. In addition, all or any part of each of processing functions performed in the individual devices can be implemented by a CPU and a program analytically executed by the CPU or can alternatively be implemented as hardware based on wired logic.

All or part of each processing described in the present embodiment as processing performed automatically may also be performed manually or, alternatively, all or part of each processing described as processing performed manually may also be performed automatically by using a known method. Additionally, a processing procedure, a control procedure, specific names, information including various data and parameters described in the above documents and illustrated in the drawings can optionally be changed unless otherwise specified.

[Program]

In an embodiment, the learning device 10 and the estimation device 20 can be implemented by installing, on an intended computer, a learning program that executes the learning processing described above as package software or online software. For example, by causing an information processing device to execute the learning program described above, it is possible to cause the information processing device to function as the learning device 10. The information processing device mentioned herein includes a desk-top or notebook personal computer. In addition, mobile communication terminals such as a smartphone, a mobile phone, and a PHS (Personal Handyphone System), a slate terminal such as a PDA (Personal Digital Assistant), and the like are included in the category of the information processing device.

The learning device 10 can also be implemented as a learning server device that uses a terminal device used by a user as a client and provides service related to the learning processing described above to the client. For example, the learning server device is implemented as a server device that provides learning service of receiving graph data input thereto and outputting a result of graph signal processing or analysis of the graph data. In this case, the learning server device may be implemented as a Web server or may also be implemented as a cloud that provides service related to the learning processing described above by outsourcing.

FIG. 7 is a diagram illustrating an example of a computer that executes a learning program or an estimation program. A computer 1000 includes, e.g., a memory 1010 and a CPU 1020. The computer 1000 also includes a hard disk drive interface 1030, a disk drive interface 1040, a serial port interface 1050, a video adapter 1060, and a network interface 1070. These units are connected by a bus 1080.

The memory 1010 includes a ROM (Read Only Memory) 1011 and a RAM 1012. The ROM 1011 stores a boot program for, e.g., BIOS (BASIC Input Output System) or the like. The hard disk drive interface 1030 is connected to the hard disk drive 1090. The disk drive interface 1040 is connected to a disk drive 1100. For example, a detachable storage medium such as a magnetic disk or an optical disk is inserted into the disk drive 1100. The serial port interface 1050 is connected to, e.g., a mouse 1110 and a keyboard 1120. The video adapter 1060 is connected to, e.g., a display 1130.

The hard disk drive 1090 stores, e.g., an OS 1091, an application program 1092, a program module 1093, and program data 1094. In other words, a program defining each of processing in the learning device 10 and processing in the estimation device 20 is implemented as the program module 1093 in which a code executable by a computer is described. The program module 1093 is stored in, e.g., the hard disk drive 1090. For example, the program module 1093 for executing the same processing as that executed by a functional configuration in the learning device 10 or the estimation device 20 is stored in the hard disk drive 1090. Note that the hard disk drive 1090 may also be replaced by a SSD.

The setting data to be used in the processing in the embodiment described above is stored as program data 1094 in, e.g., the memory 1010 or the hard disk drive 1090. Then, the CPU 1020 reads, as required, the program module 1093 or the program data 1094 stored in the memory 1010 or the hard disk drive 1090 into the RAM 1012 and performs the processing in the embodiment described above.

Note that the storage of the program module 1093 and the program data 1094 is not limited to a case where the program module 1093 and the program data 1094 are stored in the hard disk drive 1090. For example, the program module 1093 and the program data 1094 may also be stored in a detachable storage medium and read by the CPU 1020 via the disk drive 1100 or the like. Alternatively, the program module 1093 and the program data 1094 may also be stored in another computer connected via a network (such as LAN (Local Area Network) or WAN (Wide Area Network)). Then, the program module 1093 and the program data 1094 may also be read by the CPU 1020 from the other computer via the network interface 1070.

### REFERENCE SIGNS LIST

10 Learning device
11, 21 Input unit
12, 22 Extraction unit
13 Learning unit
14 Storage unit
20 Estimation device
23 Estimation unit
25 Output unit
131, 232 Latent representation calculation unit
132 Domain-by-domain objective function generation unit
133 All-domain objective function generation unit
134 Update unit
231 Model acquisition unit
233 Score calculation unit

1. A learning device comprising:
latent representation calculation circuitry that uses a first model to calculate, from samples belonging to a domain, a latent representation representing a feature of the domain;
objective function generation circuitry that generates, from the samples belonging to the domain and from the latent representation of the domain calculated by the latent representation calculation circuitry, an objective function related to a second model that calculates an anomaly score of each of the samples; and
update circuitry that updates the first model and the second model so as to optimize the objective functions of a plurality of the domains calculated by the objective function generation circuitry.

2. The learning device according to claim 1, wherein
the latent representation calculation circuitry calculates the latent representation based on a Gaussian distribution which is represented as an output obtained by further inputting of the total sum of the outputs obtained through inputting of each of the samples belonging to the domain to a first neural network to a second neural network by each of the mean function and the covariance function and
the update circuitry updates, as the first model, the first neural network and the second neural network for each of the mean function and the covariance function.

3. The learning device according to claim 1, wherein the objective function generation circuitry generates the objective function by using an expected value of the latent representation in accordance with the distribution.

4. The learning device according to claim 1, wherein the objective function generation circuitry generates, as the objective function, a function that calculates an average of the anomaly scores of normal samples or a function that subtracts an approximation of an AUC (Area Under the Curve) from the average of the anomaly scores of the normal samples.

5. The learning device according to claim 1, wherein the objective function generation circuitry generates the objective function based on a reconstruction error when the samples and the latent representation calculated by the latent representation calculation circuitry are input to an autoencoder to which the latent representation can be input.

6. An estimation device comprising:
latent representation calculation circuitry that calculates, from samples belonging to a domain and by using a first model that calculates a latent representation representing a feature of the domain, the respective latent representations of a plurality of related domains related to a target domain; and
score calculation circuitry that inputs each of the latent representations of the related domains together with a sample from the target domain to a second model that calculates, from the samples belonging to the domain and from the latent representation of the domain calculated by using the first model, an anomaly score of each of the samples, and calculates an average of the anomaly scores obtained from the second model.

7. A learning method to be implemented by a computer, the learning method comprising:
a latent representation calculation step of using a first model to calculate, from samples belonging to a domain, a latent representation representing a feature of the domain;
an objective function generation step of generating, from the samples belonging to the domain and from the latent representation of the domain calculated by the latent representation calculation step, an objective function related to a second model that calculates an anomaly score of each of the samples; and
an update step of updating the first model and the second model so as to optimize the objective functions of a plurality of the domains calculated by the objective function generation step.

8. A non-transitory computer readable medium storing a learning program for causing a computer to function as the learning device according to claim 1.

9. The learning method according to claim 7, wherein
the latent representation calculation step calculates the latent representation based on a Gaussian distribution which is represented as an output obtained by further inputting of the total sum of the outputs obtained through inputting of each of the samples belonging to the domain to a first neural network to a second neural network by each of the mean function and the covariance function and
the update step updates, as the first model, the first neural network and the second neural network for each of the mean function and the covariance function.

10. The learning method according to claim 7, wherein the objective function generation step generates the objective function by using an expected value of the latent representation in accordance with the distribution.

11. The learning method according to claim 7, wherein the objective function generation step generates, as the objective function, a function that calculates an average of the anomaly scores of normal samples or a function that subtracts an approximation of an AUC (Area Under the Curve) from the average of the anomaly scores of the normal samples.

12. The learning method according to claim 7, wherein the objective function generation step generates the objective function based on a reconstruction error when the samples and the latent representation calculated by the latent representation calculation step are input to an autoencoder to which the latent representation can be input.
